(19) United States
(12) Patent Application Publication
(10) Pub. No.: US 2009/0195079 A1
(43) Pub. Date: Aug. 6, 2009

(54) Circuit for equalizing charge unbalances in storage cells

(76) Inventor: Jens Barrenscheen, Munich (DE)

Correspondence Address: SLATER & MATSIL LLP, 17950 PRESTON ROAD, SUITE 1000, DALLAS, TX, 75252, US

(21) Appl. No.: 12/023,100

(22) Filed: Jan. 31, 2008

(51) Int. Cl. H02M 3/04

(52) U.S. Cl. 307/109

(57) ABSTRACT

A description is given of a circuit arrangement for charge exchange between capacitive storage cells, and a method for charge exchange between capacitive storage cells.

### BACKGROUND

In chargeable storage arrangements, such as e.g. rechargeable batteries, having a number of capacitive storage cells connected in series, charge unbalances can occur during the charging of the storage arrangement or during operation. Such a charge unbalance is present when the charge states of individual storage cells differ from one another. Such a difference occurs when individual cells are discharged to a greater extent than other cells during a discharging process or when individual cells are charged to a greater extent than other cells during a charging process.

Such charge unbalances can have a considerable influence on the useable storage capacity of the storage arrangement. This is because there are types of rechargeable batteries, such as e.g. lithium ion rechargeable batteries, in which the storage cells can be damaged if they are charged beyond an upper storage limit or if they are discharged below a lower storage limit. It is known to equalize such charge unbalances. This prevents a charging process from having to be ended because one of the cells has reached the upper storage limit, even though the other cells could still be charged, or a discharging process from having to be ended because one of the cells has reached a lower storage limit, even though the other cells may still be discharged further. Such equalization involves discharging more highly charged cells in favor of more weakly charged cells, or charging more weakly charged cells at the expense of more highly charged cells. The charge states of the individual cells match one another as a result of this.

For such charge exchange provision may be made of a flyback converter having a primary winding connected to the connecting terminals of the rechargeable battery arrangement, having a plurality of secondary windings which are respectively connected to the rechargeable batteries, wherein the secondary windings are coupled to the primary winding via a transformer core. However, such a flyback converter is cost-intensive and, owing to the transformer core required, costly in terms of space.

For charge equalization it is furthermore also possible to use passive components, such as resistors, for example, which can be connected in parallel with one or a plurality of cells in order to discharge more highly charged cells to the level of more weakly charged cells. Charge equalization between individual cells does not take place in this case, rather energy is drawn from more highly charged cells in this case.

### SUMMARY

A first aspect of the present description relates to a circuit arrangement for charge exchange between capacitive storage cells, comprising: a first connecting terminal pair for connection of a first storage cell; a second connecting terminal pair for connection of a second storage cell; an inductive charge storage element; and a switch arrangement, which is designed to connect the inductive storage element during temporally successive switching periods respectively between connecting terminals of the first connecting terminal pair for a first time duration and between connecting terminals of the second connecting terminal pair for a second time duration.

A second aspect relates to a method for charge exchange between capacitive storage cells, comprising: providing an inductive charge storage element; and during temporally successive switching periods, connecting the inductive storage element respectively in parallel with the first storage cell for a first time duration and in parallel with the second storage cell for a second time duration.

A third aspect relates to a circuit arrangement comprising: a first capacitive storage cell and a second capacitive storage cell; an indicative charge storage element; a switch arrangement, which is designed to connect the inductive storage element during temporally successive switching periods respectively in parallel with the first storage cell for a first time duration and in parallel with the second storage cell for a second time duration.

### BRIEF DESCRIPTION OF THE FIGURES

Exemplary embodiments are explained in more detail below with reference to figures. The figures serve for elucidating the basic principle, such that only the components necessary for understanding the basic principle are illustrated. In the figures, unless specified otherwise, identical reference symbols designate identical circuit components and signals with the same meaning.

FIG. 1 shows a circuit arrangement for charge exchange between capacitive storage cells.

FIG. 2 illustrates various possibilities for realization of the storage cells.

FIG. 3 illustrates the functioning of the circuit arrangement illustrated in FIG. 1 on the basis of time profiles for the case where the storage cells have identical charge states.

FIG. 4 illustrates the functioning of the circuit arrangement for the case of a first charge unbalance.

FIG. 5 illustrates the functioning of the circuit arrangement for the case of a second charge unbalance.

FIG. 6 shows a first exemplary embodiment of a drive circuit for generating drive signals for switching elements in the circuit arrangement.

FIG. 7 shows a second exemplary embodiment of a drive circuit for generating the drive signals.

FIG. 8 illustrates the functioning of the drive circuit in accordance with FIG. 7 on the basis of temporal signal profiles.

FIG. 9 shows a further exemplary embodiment of a drive circuit for generating the drive signals.

FIG. 10 illustrates the functioning of the drive circuit illustrated in FIG. 9 on the basis of temporal signal profiles.

FIG. 11 shows one example of an enable circuit for generating an enable signal for the circuit arrangement.

FIG. 12 shows a further example of an enable circuit for generating an enable signal.

FIG. 13 shows a further example of an enable circuit for generating an enable signal.

FIG. 14 shows a circuit detail for the drive circuit illustrated in FIG. 9.

FIG. 15 shows a charge storage arrangement with a plurality of storage cells connected in series and with a plurality of circuit arrangements for charge exchange between individual storage cells.

FIG. 16 shows a further circuit arrangement with a plurality of storage cells connected in series and with a plurality of circuit arrangements for charge exchange between individual storage cells.

FIG. 17 shows a further example of a circuit arrangement for charge exchange between capacitive storage cells.

### DETAILED DESCRIPTION OF THE FIGURES

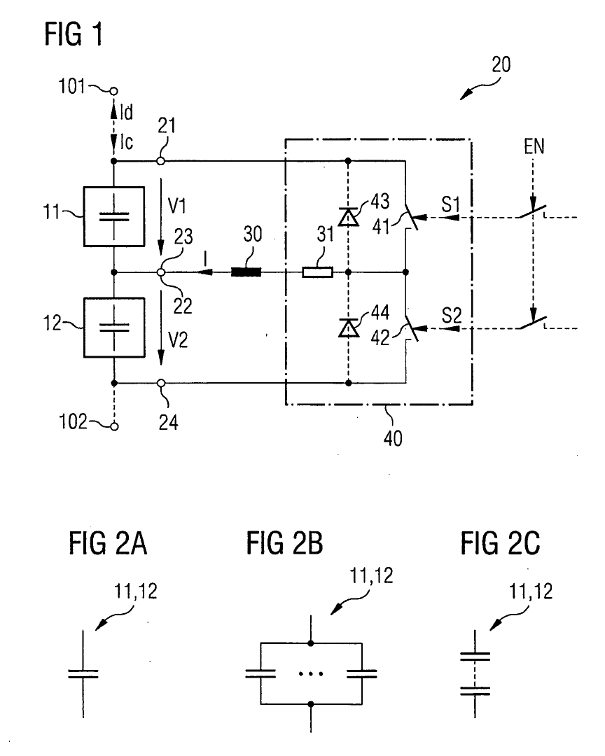

FIG. 1 shows an example of a circuit arrangement 20 for charge exchange between capacitive storage cells of a rechargeable charge storage arrangement. This charge storage arrangement is a rechargeable battery, for example, such as a lithium ion rechargeable battery, for example, and has a plurality of storage cells 11, 12 connected in series. Only two of such storage cells 11, 12 connected in series are illustrated in FIG. 1. It goes without saying that the charge storage arrangement can have more than two storage cells connected in series, as is illustrated graphically by dots in FIG. 1. The storage cells 11, 12 are connected between connecting terminals 101, 102 of the charge storage arrangement. Said connecting terminals 101, 102 serve for connection of the charge storage arrangement to a load (not illustrated) to be supplied or for connection of the charge storage arrangement to a charging circuit (not illustrated). The individual storage cells 11, 12 each have two connections between which a supply voltage V1, V2 is available. In this case, the sum of the supply voltages of the storage cells connected in series corresponds to the supply voltage made available for the load by the entire charging circuit between the connecting terminals 101, 102.

Referring to FIG. 2A, the individual storage cells 11, 12 can each have a capacitive storage element. The capacitor circuit symbol illustrated in FIG. 2A represents such a storage cell in this case. Referring to FIG. 2B, a storage cell 11, 12 can also have a plurality of storage elements connected in parallel. Furthermore, a storage cell 11, 12 can also have a plurality of storage elements connected in series, as is illustrated in FIG. 2C.

The individual storage cells connected in series are coordinated with one another in particular in such a way that they have the same nominal voltage. In this case, “nominal voltage” should be understood to mean the supply voltage that a storage cell makes available in the fully charged state. In the realization variants illustrated in FIGS. 2A and 2B, the nominal voltage of a storage cell 11, 12 corresponds to the nominal voltage of the storage elements respectively used. In the realization variant in accordance with FIG. 2C, the nominal voltage of a storage cell corresponds to the sum of the nominal voltage of the storage elements connected in series.

On account of manufacturing-dictated tolerances, the individual storage cells 11, 12 can differ with regard to their electrical properties to the effect that they have different capacitances, for example. This can have the effect that during a charging process in which the storage arrangement is charged with a charging current Ic by a charging circuit, individual storage cells are charged up to a specific voltage, for example the nominal voltage, more rapidly than other storage cells. In a corresponding manner it can happen that during a discharging process in which the charge storage arrangement is discharged with a discharge current Id, individual storage cells are discharged to a predetermined voltage more rapidly than other storage cells. There are types of storage cells, such as storage cells of lithium ion rechargeable batteries, for example, which should not be charged beyond an upper voltage limit, and which should not be discharged below a lower voltage limit, in order to avoid damage to the storage cells. Said upper voltage limit is referred to hereinafter as the charging limit, and the lower voltage limit is referred to hereinafter as the discharging limit. Furthermore, the individual storage cells can also differ with regard to their internal resistance.

It shall be assumed for the explanation below that a charge state of a storage cell is represented by the supply voltage present across the storage cell. Both during charging and during discharging of the charge storage arrangement, it is desirable here for all the storage cells to have at least approximately identical charge states. An optimum utilization of the total storage capacity of the charge storage arrangement is ensured in this case.

For equalizing existing charge unbalances or for matching the charge states of two storage cells 11, 12 to one another, a circuit arrangement 20 is provided, which is referred to hereinafter as equalization circuit. The equalization circuit 20 illustrated in the example has a first connecting terminal pair having two connecting terminals 21, 23 for connection of a first storage cell 11 and a second connecting terminal pair having connecting terminals 22, 24 for connection of a second storage cell 12. The two storage cells 11, 12 are directly connected in series in the example illustrated. A second connecting terminal 23 of the first connecting terminal pair 21, 23 and a first connecting terminal 22 of the second connecting terminal pair 22, 24 are in this case realized by a common connection connected to a circuit node that is common to the two storage cells 11, 12.

The equalization circuit 20 additionally has an inductive storage element 30 and a switching arrangement 40. The switching arrangement 40 is designed to connect the inductive storage element 30 during successive switching periods respectively between the connecting terminals of the first connecting terminal pair 21, 23, and thus in parallel with the first storage cell 11, for a first time duration and to connect the inductive storage element 30 between the connecting terminals 22, 24 of the second connecting terminal pair, and thus in parallel with the second storage cell 12, during a subsequent second time duration.

In the example illustrated, the inductive storage element 30 is connected to the connection 22, 23 that is common to the connecting terminal pairs. In this case, the switching arrangement 40 has a first switching element 41, which is connected between the first connecting terminal 21 of the first connecting terminal pair and the inductive storage element 30, and a second switching element 42, which is connected between the second connecting terminal 24 of the second connecting terminal pair and the inductive storage element 30. The inductive storage element 30 is connected in parallel with the first storage cell 11 when the first switching element 41 is driven in the on state and the second switching element 42 is disposed in the off state, and is connected in parallel with the second storage cell 12 when the first witching element 41 is driven in the off state and the second switching element 42 is driven in the on state.

The switching elements 41, 42 can be any desired switching elements, in particular semiconductor switching elements, such as e.g. MOSFETs, IGBTs or bipolar transistors. The first and second switching elements 41, 42 are turned on and turned off according to a first and second drive signal S1, S2. It shall be assumed for the explanation below that the switching elements 41, 42 are turned on at an upper signal level (high level) of the respective drive signal and are turned off at a lower signal level (low level) of the respective drive signal. Depending on the realization of the switching elements 41, 42, driver circuits may be required for driving the individual switching elements, said driver circuits converting the drive signals S1, S2 to signal levels suitable for driving the switching elements 41, 42. Such driver circuits are known in principle and are not illustrated in FIG. 1 for reasons of clarity.

The functioning of the equalization circuit 20 illustrated in FIG. 1 is explained below with reference to FIG. 3 using signal profiles for the first and second drive signals S1, S2 and of a current I through the inductive storage element 30. FIG. 3 shows the first and second drive signals S1, S2 during a plurality of successive switching periods each having an identical period duration T. In this case, the two switching elements 41, 42 are driven in such a way that during a switching period, for a first switch-on duration T1, the first switching element 41 is driven in the on state and the second switching element 42 is driven in the off state and, for a second switch-on duration T2, the first switching element 41 is driven in the off state and the second switching element 42 is driven in the on state.

It shall be assumed for the explanation below that a first duty cycle is defined by the ratio between the first switch-on duration T1 and a period duration T of the switching period and that a second duty cycle is defined by the ratio between the second switch-on duration T2 and the period duration T. For the purposes of the explanation it shall initially be assumed that the first and second duty cycles are in each case equal in magnitude and in each case amount to 50%.

During the first switch-on duration T1, the inductive storage element 30 is connected in parallel with the first storage cell 11. If parasitic resistances are disregarded, then the following holds true for a temporal change dI/dt in the current I through the inductive storage element 30 during said first switch-on duration T1:

$$\frac{d I}{d t} = \frac{V 1}{L} \qquad ( 1 a )$$

In this case, V1 denotes the voltage across the first storage cell 11 and L denotes the inductance of the inductive storage element 30. During the second switch-on duration T2, the inductive storage element 30 is connected in parallel with the second storage cell 12. The following holds true in this case for a temporal change dI/dt in the current I:

$$\frac{d I}{d t} = \frac{V 2}{L} \qquad ( 1 b )$$

In this case, V2 denotes the voltage across the second storage cell 12.

For the purposes of the explanation it shall be assumed that the first and second voltages V1, V2 are in each case positive voltages present between the first and second connecting terminals of the respective connecting terminal pair. In this case, the current I through the inductive storage element rises proportionally to the first voltage V1 during the first switch-on duration T1, and falls proportionally to the second voltage V2 during the second switch-on duration T2.

The temporal profile of the current I through the inductive storage element 30 as illustrated in FIG. 3 corresponds to the temporal profile for identical voltages V1, V2 in the steady-state condition. In this case, the gradient of the current rise during the first switch-on duration T1 corresponds to the gradient of the current fall during the second switch-on duration T2. In the steady-state condition, that is to say after a number of switching periods have already taken place, the current I changes its polarity in each case toward the middle of the first and second switch-on durations T1, T2. The average value of the current I as considered over a switching period T is zero in this case. As considered over a total switching period T, therefore, no change in the charges stored in the storage cells 1, 12 takes place. Consequently, given identical voltages V1, V2 across the storage cells 11, 12, no charge exchange takes place—as considered over a total switching period T. It should be noted in this connection that the inductance of the inductive storage element 30 and the switching period T are coordinated with the storage capacities of the storage cells 11, 12 in such a way that the electrical energy taken up by the inductive storage element 30 during a switching period only represents a small fraction of the electrical energy that can be stored in the storage cells 11, 12. This prevents the electrical voltage of a storage cell from changing during a switching period to such a great extent that an undesired oscillation behavior can occur overall. This energy subjected to charge reversal during a switching period can be influenced for example by the duty cycle of the drive signal.

If both storage cells 11, 12 have identical charge states, and thus identical voltages V1, V2, when an equalization process is begun, then during first switching periods (not illustrated), firstly one of the storage cells is charged somewhat at the expense of the other storage cells, whereby the voltage across this storage cell firstly rises relative to the voltage across the other storage cell. If, at the beginning of such an equalization process, for example the first switching element 41 is firstly driven in the on state, then the first storage cell 11 is firstly discharged, while the second storage cell 12 is firstly charged. After a few switching periods, this charge balance established at the beginning of the equalization process is equalized, however, until the situation illustrated in FIG. 3 is reached.

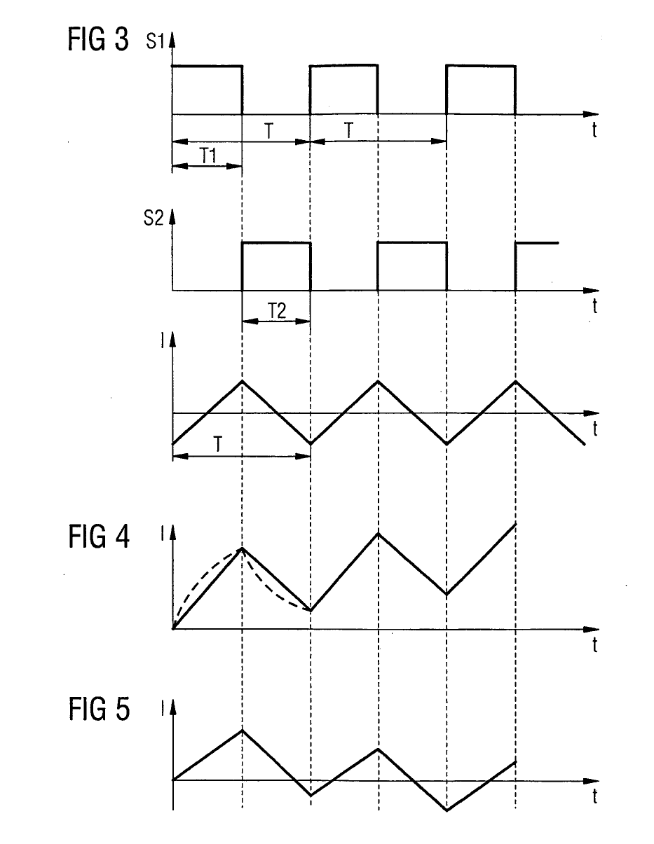

It should be pointed out that the time profile in FIG. 3 and the time profiles in FIGS. 4 and 5 yet to be explained, which serve merely for elucidating the basic principle, are based on the idealizing assumption that no parasitic resistances are present, that is to say that neither the connecting lines between the storage cells 11, 12 nor the switching element 41, 42 are affected by resistance. The triangular-waveform signal profiles of the current through the inductance 30 as illustrated in FIG. 3 result from this idealizing assumption. In actual fact, such resistances are unavoidably present. The reference symbol 31 in FIG. 1 designates a nonreactive resistance representing the nonreactive resistances present in the respectively conducting current path between the cells 11, 12. The inductive storage element and said nonreactive resistances form an RL element in the respectively conducting current path, said RL element having the effect that the actual time profiles are exponential time profiles, as is represented by dashed lines in FIG. 3. In this case, the resistive portion of said RL element affects the time profile to a greater extent, the higher the current flowing.

FIG. 4 illustrates the temporal profile of the current I through the inductive storage element 30 at the beginning of an equalization process for the case where the first storage cell 11 is charged to a greater extent than the storage cell 12. In this case, the first voltage V1 is greater than the second voltage V2. Assuming that the current through the inductive storage element 30 is zero at the beginning of the equalization process, the current rises at the beginning of the equalization process proceeding from zero with a gradient corresponding to the voltage V1 across the first storage cell 11. On account of the lower voltage of the second storage cell 12, the current does not fall to zero during the subsequent second switch-on duration T2. At the beginning of this equalization process, an average value of the current I can initially rise over a plurality of switching periods. In this case, this current rise or the number of switching periods over which the current rises is dependent on the difference in tie charge states of the storage cells 11, 12 or dependent on a difference between the first and second voltages V1, V2. As the discharging of the first storage cell increases, the average value of the current begins to fall after a few switching periods, in a manner not illustrated in more specific detail, until the situation illustrated in FIG. 3 is established. Owing to the nonreactive resistances, or owing to the presence of the RL element, oscillation processes are avoided to the effect that the second storage cell is temporarily charged beyond the charge state of the first storage cell 11.

FIG. 5 shows the temporal profile of the current I at the beginning of an equalization process for the case where the first storage cell 11 is charged more weakly than the second storage cell 12. In this case, the first voltage V1 is less than the second voltage V2. Assuming that the first switch S1 is initially closed, the average value of the current I in this case initially has a positive sign, but changes its polarity during further switching periods and, after still further switching periods have elapsed, is adjusted to zero in a manner not illustrated in more specific detail, thus resulting in the situation illustrated in FIG. 3. An oscillation behavior to the effect that the average value of the current repeatedly changes its polarity until it is adjusted to zero is prevented by the nonreactive resistances that are unavoidably present.

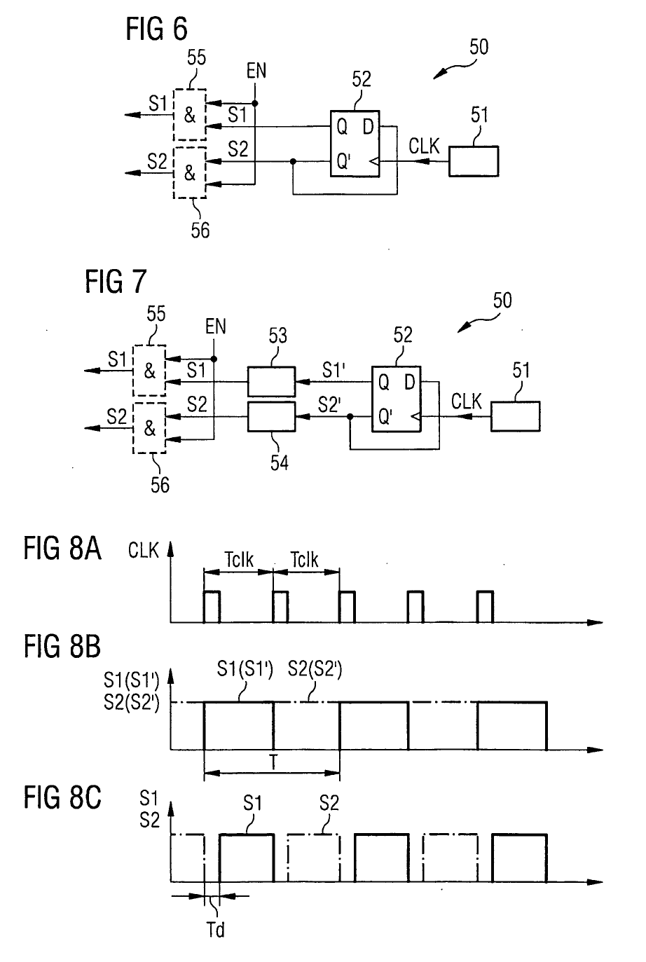

The generation of the first and second drive signals S1, S2 complementarily to one another in such a way that they alternately assume a switch-on level (high level) and a switch-off level (low level), and that both signals never assume a switch-on level simultaneously, can be effected by any desired drive circuits. One example of such a drive circuit 50 for generating the two drive signals S1, S2 is illustrated in FIG. 6. This circuit arrangement has a clock generator 51, which provides a clock signal CLK, which prescribes the duration of the driving period T. A D-type flip-flop is connected downstream of said clock generator 51, the clock signal CLK being fed to the clock input of said flip-flop and said flip-flop having a noninverting output Q and an inverting output Q′, of which the inverting input Q′ is coupled with feedback to the data input D. The signals available at the outputs Q, Q′ are complementary to one another. In this case, one of said signals—in the example the signal at the noninverting output Q—corresponds to the first drive signal S1, while the other of said signals—in the example the signal at the inverting output Q′—corresponds to the second drive signal S2. These output signals change their signal levels with the timing of the clock signal CLK. In this case, the period duration of a switching period corresponds to two period durations Tclk of the clock signal.

FIGS. 8A and 8B illustrate temporal profiles of the first and second drive signals S1, S2 depending on the temporal profile of the clock signal CLK for the drive circuit illustrated in FIG. 6. Here the first and second switch-on durations T1, T2 are in each case equal in magnitude, resulting in first and second duty cycles of 50% in each case, and correspond to a period duration Tclk of the clock signal.

In order to ensure that the two switching elements 41, 42 are never driven in the on state simultaneously, and in order thus to avoid a short circuit of the two storage cells 11, 12 connected in series, the two switching elements 41, 42 can be driven in the on state in a manner temporally offset with respect to one another. In this case, a switch-on level of one of the two drive signals is generated only after a delay duration Td has elapsed after the other one of the two drive signals assumes a switch-off level. In this case, both switching elements 41, 42 can be turned off at least during part of said delay duration Td. A time duration during which both switching elements are turned off is also referred to as a dead time.

In order, during such time durations during which both switching elements 41, 42 are turned off, to prevent overvoltages from occurring owing to an electrical energy previously stored in the inductive storage element 30, freewheeling elements 43, 44 can be provided in parallel with the switching elements 41, 42. In this case, a first freewheeling element 43 is connected in parallel with the first switching element 41 and a second freewheeling element 44 is connected in parallel with the second switching element 42. The freewheeling elements, which are illustrated by dashed lines in FIG. 1, are realized for example as diodes connected up in such a way that the cathodes thereof are connected to the positive connection of the respective storage cells 11, 12 directly—as in the example of the freewheeling element 43—or indirectly via the inductive storage element 30—as in the example of the freewheeling element 44. In the example illustrated, the positive connections are in each case the first connecting terminals 21, 22 of the storage cells. If the inductive storage element 30 takes up energy for example when the first switching element 41 is closed, then the second freewheeling element 44 enables a commutation of the inductive storage element 30 by charging of the second storage cell 12. If, conversely, the inductive storage element 30 takes up energy when the second switching element 42 is closed, then the first freewheeling element 43, when the second switching element 42 is subsequently turned off and the first switching element 41 is not yet turned on, enables the commutation of the inductive storage element 30 by charging of the first storage cell 11. This prevents overvoltages that otherwise might lead to damage or destruction of the equalization circuit 20.

The switching elements used can be, in particular, those switching elements which already have an integrated freewheeling diode. Such switching elements are power MOSFETs, for example. Power MOSFETs have an integrated body diode which, in the case of n-channel MOSFETs, is connected in the forward direction between a source connection and a drain connection and which can be used as a freewheeling element. In this case, the MOSFET should be connected up in the switching arrangement 40 in such a way that the desired polarity of the freewheeling diode is achieved.

FIG. 7 shows an example of a drive circuit which generates the first and second drive signals S1, S2 in such a way that a switch-on level of one drive signal is generated only after a delay duration Td has elapsed after the other drive signal assumed a switch-off level. This drive circuit 50 differs from the one illustrated in FIG. 6 by virtue of the fact that asymmetrical delay elements 53, 54 are connected downstream of the outputs Q, Q′ of the flip-flop 52, which delay elements transmit falling edges of the output signals S1′, S2′ of the flip-flop 52 without any delay and transmit the rising edge of said output signals S1′, S2′ in a manner subjected to a time delay with a delay duration Td. In this case, falling edges represent a transition in the respective output signal from a switch-on level to a switch-off level, while rising edges respectively represent a transition in the respective output signal from a switch-off level to a switch-on level.

FIG. 8B illustrates temporal profiles of the output signals S1′, S2′ of the flip-flop 42 for the drive circuit in accordance with FIG. 7. FIG. 8C shows the drive signals S1, S2 which result from said output signals S1′, S2′ and which are present at the outputs of the asymmetrical delay elements 53, 54. Referring to FIG. 8C, a rising edge of an output signal S1′ at the noninverting output of the flip-flop 52 leads to a rising edge of the first drive signal S1 only with a time delay Td, while a rising edge of an output signal S2′ at the inverting output Q′ of the flip-flop 52 leads to a rising edge of the second drive signal S2 only after a delay duration Td.

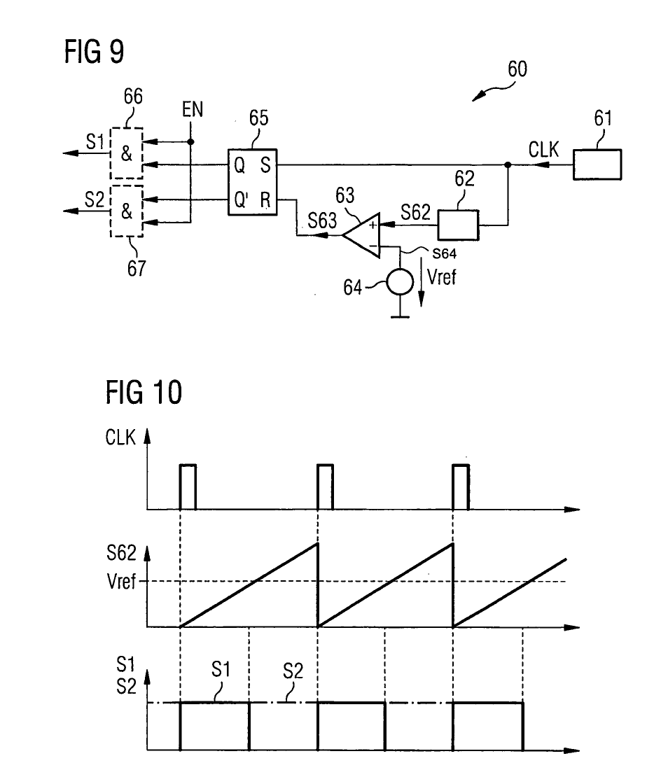

FIG. 9 shows a further exemplary embodiment of a drive circuit 60 for generating the drive signals S1, S2. This drive circuit illustrated in FIG. 9 is realized as a pulse width modulator and has a clock generator 61 for generating a clock signal CLK, a ramp signal generator 62 for generating a ramp signal according to the clock signal CLK, a reference voltage source 64, a comparator 63 and a flip-flop 65. In this case, an output signal S62 of the ramp signal generator 62 is fed to a first input—in the example the noninverting input—of the comparator 63. A reference voltage Vref provided by the reference voltage source 64 is fed to a second input—in the example the inverting input—of the comparator 63. In the example illustrated, the flip-flop 65 is realized as an RS flip-flop and has a set input S, to which the clock signal CLK is fed, and has a reset input R, to which an output signal S63 of the comparator is fed. The flip-flop 65 additionally has a first—in the example noninverting—output Q and a second—in the example inverting—output Q′. An output signal at the noninverting output Q corresponds to the first drive signal S1 in the example illustrated, while an output signal at the inverting output Q′ corresponds to the second drive signal S2 in the example illustrated.

The functioning of the drive circuit 60 illustrated in FIG. 9 becomes clear on the basis of temporal profiles of the clock signal CLK, of the ramp signal S62 and of the first and second drive signals S1, S2 as illustrated in FIG. 10. The flip-flop 65 is set in each case with the timing of the clock signal CLK, where with each clock pulse of the clock signal CLK the first drive signal S1 assumes a switch-on level and the second drive signal S2 assumes a switch-off level. The ramp signal generator 62 is realized in such a way that an output signal S62 rises in ramped fashion proceeding from an initial value, for example zero, with each clock pulse of the clock signal CLK. The comparator 63 compares the output signal S62 of the ramp signal generator 62 with the reference voltage Vref and resets the flip-flop 65 in each case when the ramp signal S62 reaches the value of the reference voltage Vref. At this point in time, the first drive signal S1 assumes a switch-off level and the second drive signal S2 assumes a switch-on level. In this drive circuit, the duty cycle of the two drive signals S1, S2 is dependent on the reference signal Vref. Said reference signal Vref is chosen for example in such a way that its value corresponds to 50% of the amplitude assumed by the ramp signal during a clock period Tclk. A duty cycle of the two drive signals S1, S2 corresponds to 50% in this case. Consequently, in this drive circuit, the duty cycle of the drive signals S1, S2 and thus also a desired ratio of the voltages V1, V2 across the storage cells can be set by means of the reference signal Vref.

The drive circuit 60 illustrated in FIG. 9 can be modified in a manner corresponding to the drive circuit in accordance with FIG. 7 to the effect that asymmetrical delay elements are connected downstream of the outputs Q, Q′ of the flip-flop 65. In this case, the first and second drive signals S1, S2 are generated in such a way that there is a temporal offset between a falling edge of one drive signal and the subsequent rising edge of the drive signal.

One exemplary embodiment provides for carrying out a charge exchange between the storage cells 11, 12 only when such a charge exchange is necessary, or for carrying out a charge equalization only for as long as such a charge equalization is necessary. Losses which occur unavoidably during each equalization process can be reduced in this way. Referring to FIG. 1, an enable signal EN can be provided for this purpose, which signal prevents the switching elements 41, 42 from being driven in the on state if no charge equalization is to take place. In order to prevent the switching elements 41, 42 from being driven in the on state, it is possible for example to interrupt a drive signal path to control connections of the switching elements 41, 42. Two switching elements which are driven by the enable signal EN and are illustrated in FIG. 1 in this case represent means for such interruption of the drive signal current path depending on the enable signal EN.

In the case of the drive circuits illustrated in FIGS. 6 and 7, AND gates 55, 56 can be provided, which respectively combine the drive signals S1, S2 with the enable signal EN. In this case, clocked driving of the switching elements 41, 42 is effected only when the enable signal EN assumes an enable level—a high level in the example illustrated. In a corresponding manner AND gates 66, 67 can be provided in the case of the drive circuit 60 illustrated in FIG. 9, said AND gates combining output signals of the flip-flop 65 with the enable signal EN.

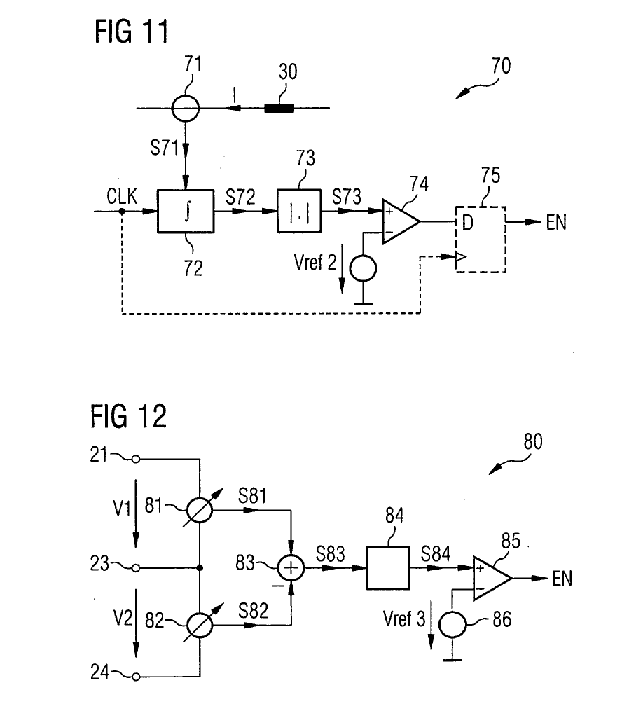

Referring to FIG. 11, the enable signal EN is generated for example by an enable signal generating circuit 70, which is designed to average the current I through the inductive storage element 30 over the period duration T of a switching period, to compare a magnitude of this average value with a reference value Vref2 and to generate the enable signal EN depending on this comparison. The enable signal generating circuit 70 illustrated has a current measuring arrangement 71, which is designed to detect the current I through the inductive storage element 30 and to provide a current measurement signal S71 dependent on said current. Said current measurement signal S71 is fed to an integrator 72, which is designed to integrate the current measurement signal S71 during a switching period. An item of information about the duration of the switching period is fed to the integrator 72 in this case by means of the clock signal CLK. Depending on the drive circuit used, the integrator 72 integrates the current measurement signal S71 over one clock period or over two clock periods of the clock signal CLK, thereby achieving an integration of the current measurement signal S71 over the switching period.

An output signal S72 of the integrator 72, which signal is dependent on the integral of the current measurement signal 71 over the switching period, is fed to a magnitude forming unit 73, which forms the magnitude of the integrator output signal S72. A comparator 74 compares the magnitude signal S73 with the reference value Vref2. The enable signal EN is available at the output of said comparator 74. In this case, an enable signal EN for clocked driving of the switching elements 41, 42 is generated only when the magnitude of the average value of the current I over a switching period is greater than the second reference value Vref2. What is thereby achieved is that a charge equalization takes place only when such a charge equalization is actually necessary. This is because, referring to the explanations concerning FIG. 3, the magnitude of the average value of the current I is zero if the two storage cells 11, 12 have identical charge states. A D-type flip-flop is optionally connected downstream of the comparator 74, the comparator output signal being fed to the data input D of said flip-flop and the clock signal CLK being fed to the clock input of said flip-flop. In this case, the enable signal EN is available in a manner synchronized with the clock signal CLK according to which the drive signals S1, S2 are generated.

In order to ensure that deviating charge states of the first and second storage cells 11, 12 are detected in a timely manner after an equalization process has been ended, one exemplary embodiment provides for starting an equalization process at regular time intervals, that is to say for setting the enable signal EN to an enable level at regular time intervals (in a manner not illustrated in more specific detail) and ending the equalization process in each case when the enable signal EN assumes a switch-off level.

FIG. 12 shows a further exemplary embodiment of an enable signal generating circuit. This enable signal generating circuit 80 determines the magnitude of a difference between the first voltage V1 and the second voltage V2, compares said magnitude with a second reference value Vref3 and generates the enable signal EN depending on this comparison. First and second voltage measuring arrangements 81, 82 are provided for determining the first and second voltages V1, V2, which arrangements are respectively connected between the connecting terminals of one of the connecting terminal pairs and respectively provide a voltage measurement signal S81, S82. A subtractor 83 determines a difference between a first voltage measurement signal S81, which represents the first voltage V1, and a second voltage measurement signal S82, which represents the second voltage V2. A difference signal S83 is available at the output of said subtractor 83, said signal being fed to a magnitude forming unit 84. Said magnitude forming unit 84 forms the magnitude of the difference signal S83. A comparator 85, to which are fed a magnitude signal S84 available at the output of the magnitude forming unit 84 and the second reference signal Vref3 from a reference voltage source, provides the enable signal EN at its output. In the example illustrated, said enable signal has an enable level EN if the magnitude signal S84 is greater than the second reference value Vref3. This is tantamount to a voltage difference between the first and second voltages V1, V2 being greater than a predetermined threshold value represented by the second reference voltage Vref3.

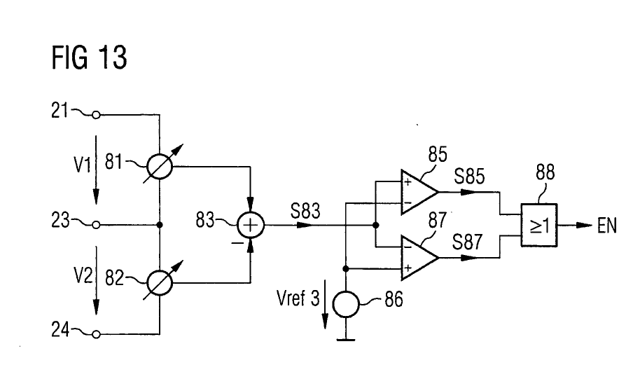

FIG. 13 shows an enable signal generating circuit modified by comparison with the enable signal generating circuit in accordance with FIG. 12. This enable signal generating circuit has two comparators 85, 87 instead of a magnitude forming unit and a comparator, said two comparators each being fed the difference signal S83 and the second reference signal Vref3 in such a way that the output signal of one of the two comparators assumes a high level when the difference signal S83 is positive and greater in magnitude than the second reference signal Vref3, and that the output signal of the other one of the two comparators assumes a high level when the difference signal S83 is negative and smaller in magnitude than the second reference signal Vref3. Output signals S85, S87 of the two comparators 85, 87 are fed to an OR gate 88, at the output of which the enable signal EN is available.

A further exemplary embodiment provides for configuring the duty cycle of the drive signals in variable fashion, to be precise depending on a difference in the charge states of the two storage cells 11, 12. In one example, provision is made here for that one of the two switching elements which serves to connect the inductive storage element 30 in parallel with the storage cell which is charged to a greater extent to be driven for longer during a switching period. In one example, provision is made here for not continuously varying the duty cycle, but rather only providing a number of discrete duty cycles and selecting one of said duty cycles depending on the difference in the charge states.

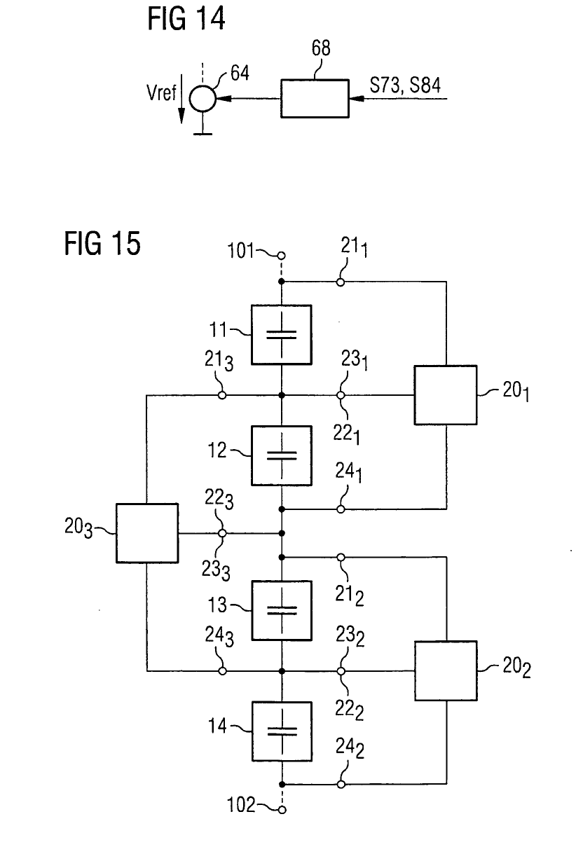

In order to provide drive signals S1, S2 having a variable duty cycle, for example the drive circuit 60 in accordance with FIG. 9 can be modified to the effect that a settable voltage source is used as reference voltage source 64, a setting signal S64 for setting the reference voltage value Vref being fed to said voltage source. The setting signal S64, which determines the duty cycle, referring to FIG. 14, is generated by a setting signal generating circuit 68 for example depending on the average value of the current I through the inductive storage element 30 or depending on a difference between the first and second voltages V1, V2. By way of example, the magnitude signals S73, S84 in accordance with FIGS. 11 and 12 can be used as a measure of the average value of the current and the voltage difference, respectively. The drive signal generating circuit 68 is designed to compare said magnitude signals with one or more predetermined threshold values and, depending on this comparison result, to set the reference voltage to one of a plurality of discrete reference voltage values, each of which represents a duty cycle.

A further exemplary embodiment provides for determining, before the beginning of an equalization process, the storage cell which has a higher charge state, that is to say across which there is a higher voltage in comparison with the other storage cell. After this storage cell having the higher voltage has been determined, that one of the two switching elements 41, 42 which is connected in parallel with the storage cell having a higher voltage, that is to say having a higher charge state, is closed first during a first switching period. A transient process, which was explained in connection with FIG. 5 and during which the average value of the equalization current changes its polarity shortly after the beginning of the equalization process, can be prevented in this way, whereby a more rapid charge equalization is achieved.

When using an enable signal generating circuit in accordance with FIG. 13, an item of information about which of the storage cells 11, 12 is charged to a greater extent can be obtained for example from the output signals of the two comparators 85, 87. In the circuit illustrated, a high level is present at the output of the first comparator 85 if the first storage cell is charged to a greater extent than the second storage cell (and if the voltage difference is greater than the second reference value Vref3), and a high level is present at the output of the second comparator 87 if the second storage cell is charged to a greater extent than the first storage cell (and if the voltage difference is greater than the second reference value Vref3).

In a manner not illustrated in more specific detail, supply voltages of the above-explained drive circuits and enable signal generating circuits can be made available directly by the storage cells, such that no further supply voltage sources are required.

It goes without saying that a plurality of the equalization circuits explained above can be provided in a charge storage arrangement having a plurality of storage cells connected in series. FIG. 14 shows one example of a charge storage arrangement having at least four storage cells 11-14 connected in series. This charge storage arrangement is provided with three equalization circuits 20₁, 20₂, 20₃, which together serve to match the charge states of all four storage cells connected in series to one another. In this case, the first equalization circuit 20₁ serves for charge equalization between a first and a second storage cell 11, 12, a second equalization circuit 20₂ serves for charge equalization between a third and a fourth storage cell 13, 14. A third equalization circuit 20₃ serves for charge equalization between the second and the third storage cell 12, 13. In this arrangement, the first and second equalization circuits 20₁, 20₂ can be operated synchronously with one another, for example by the first switching elements of the equalization circuits 20₁, 20₂ in each case being driven simultaneously and by the second switching elements of the equalization circuits 20₁, 20₂ in each case being driven simultaneously.

The cascading of equalization circuits as illustrated in FIG. 15 enables the charge states of all the storage cells to be matched to one another. In this case, the dielectric strength of the switching elements (41, 42 in FIG. 1) used in the equalization circuits 20₁, 20₂, 20₃ merely has to be high enough that the switching elements withstand the voltage across two storage cells connected in series, that is to say the voltage between the connections 21 and 24 in the circuit in accordance with FIG. 1. Consequently, components having a high dielectric strength are not required, whereby the equalization circuit can be realized in a cost-effective manner.

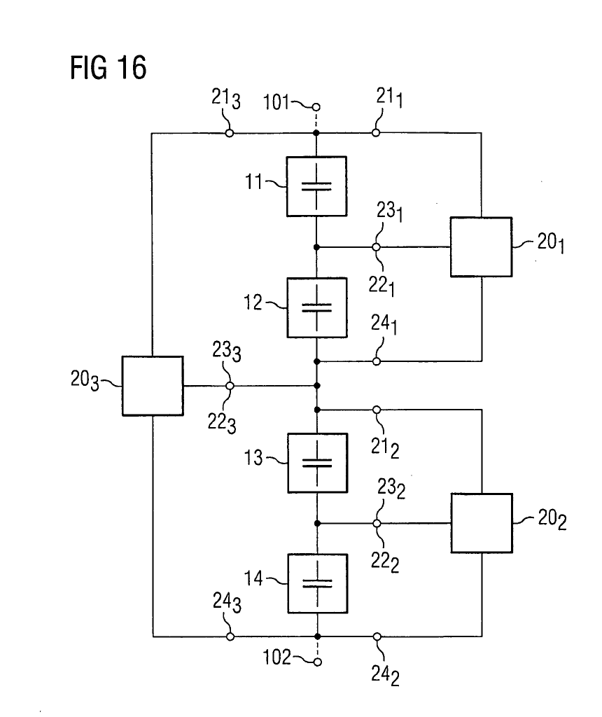

FIG. 16 shows a further arrangement comprising a charge storage arrangement having three equalization circuits 20₁-20₃. This arrangement differs from the one illustrated in FIG. 14 by virtue of the fact that the third equalization circuit 20₃ serves for charge equalization between a first combined storage cell, which is formed by a series connection of the first and second storage cells 11, 12, and a second combined storage cell, which is formed by a series connection of the third and fourth storage cells 13, 14. In this connection it should also be noted that the individual connections of the equalization circuits 20₁-20₄ illustrated in FIGS. 14 and 15 are designated by the same reference symbols as the equalization circuit 20 in accordance with FIG. 1, in order to facilitate an understanding of the functioning. Identical connections of the respective equalization circuits are distinguished here by the indices 1, 2 and 3.

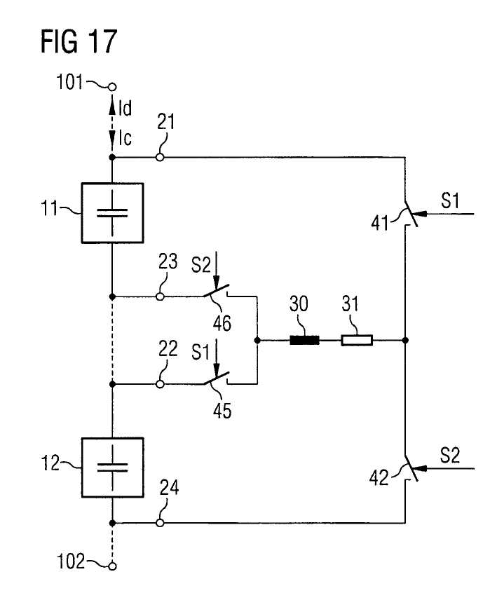

It was assumed for the explanation above that two storage cells whose charge states are to be matched have a common connection, that is to say that the second connecting terminal of one of the storage cells corresponds to the first connecting terminal of the other storage cell. Referring to FIG. 17, charge equalization between two storage cells is also possible of course, when the two storage cells are not directly connected to one another. In this case, two further switching element have to be provided: a first further switching element 45, which is connected between the inductive storage element 30 and the first connecting terminal 22 of the second storage cell 12 and which is driven synchronously with the first switching element 41 by the first drive signal S1; and a second further switching element 46, which is connected between the inductive storage element 30 and the second connecting terminal 23 of the first storage cell 11 and which is driven synchronously with the second switching element 42 by the second drive signal S2.

Charge equalization by means of the equalization circuit explained above can be effected during all the operating phases of the charge storage arrangement, that is to say during a charging process in which a charging current Ic flows into the charge storage arrangement, during a discharging process in which a discharging current Id flows from the charge storage arrangement, or during a quiescent state in which no current flows apart from the equalization currents. In this connection it should also be pointed out that the equalization circuit explained carries out charge equalization with the aim of matching the voltages present across the individual storage cells to one another. If all the storage cells have identical internal resistances, then this leads directly to matching of the charge states. If the internal resistances differ, then different charge states of the individual storage cells can occur particularly when an equalization process is effected during the charging or discharging phase, since during these phases, during which a high current in comparison with the equalization current flows, the internal resistance affects particularly the voltage present across the storage cells.

1. A circuit arrangement for charge exchange between capacitive storage cells, the arrangement comprising:
a first connecting terminal pair for connection of a first storage cell,
a second connecting terminal pair for connection of a second storage cell,
an inductive charge storage element,
a switch arrangement, which is designed to couple the inductive storage element during temporally successive switching periods respectively between connecting terminals of the first connecting terminal pair for a first time duration and between connecting terminals of the second connecting terminal pair for a second time duration.

2. The circuit arrangement as claimed in claim 1, wherein the switch arrangement comprises:
a first switching element, which together with the inductive storage element forms a first series circuit coupled between the first connecting terminal pair,
a second switching element, which together with the inductive storage element forms a second series circuit coupled between the second connecting terminal pair.

3. The circuit arrangement as claimed in claim 2, further comprising a first freewheeling element coupled in parallel with the first switching element, and a second freewheeling element coupled in parallel with the second switching element.

4. The circuit arrangement as claimed in claim 1, wherein the circuit arrangement can assume an activated state and a deactivated state and wherein, in the activated state, the inductive storage element is coupled during a time duration respectively in parallel with the first storage cell for the first time duration and in parallel with the second storage cell for the second time duration.

5. The circuit arrangement as claimed in claim 4, further comprising:
a current measuring arrangement designed to determine an average value of a current through the coil during a switching period, and
wherein the circuit arrangement assumes the deactivated state if a magnitude of said average value is less than a predetermined threshold value.

6. The circuit arrangement as claimed in claim 4, further comprising:
a voltage measuring arrangement designed to determine a difference between a first voltage present between the first connecting terminal pair, and a second voltage present between the second connecting terminal pair,
wherein the circuit arrangement assumes the deactivated state if a magnitude of said difference is less than a predetermined threshold value.

7. The circuit arrangement as claimed in claim 1, wherein the first time duration is equal to the second time duration.

8. The circuit arrangement as claimed in claim 1, wherein the first and second time durations are variable.

9. The circuit arrangement as claimed in claim 8, further comprising:
a current measuring arrangement designed to determine an average value of a current through the inductive charge storage element during a switching period, and
wherein the first and second time durations are dependent on said average value.

10. The circuit arrangement as claimed in claim 8, further comprising:
a voltage measuring arrangement designed to determine a difference between a first voltage present between the first connecting terminal pair, and a second voltage is present between the second connecting terminal pair,
wherein the first and second time durations are dependent on said difference.

11. A method for charge exchange between capacitive storage cells, comprising:
providing an inductive element,
during temporally successive switching periods, connecting the inductive element respectively in parallel with the first storage cell for a first time duration and in parallel with the second storage cell for a second time duration.

12. The method as claimed in claim 11, further comprising:
determining an average value of a current through the inductive element during a switching period, and
interrupting a charge equalization if a magnitude of said average value is less than a predetermined threshold value.

13. The method as claimed in claim 11, further comprising:
determining a difference between a first voltage across the first storage cell and a second voltage across the second storage cell,
interrupting a charge equalization if a magnitude of said difference is less than a predetermined threshold value.

14. The method as claimed in claim 11, wherein the first time duration is equal to the second time duration.

15. The method as claimed in claim 11, wherein the first and second time durations are variable.

16. The method as claimed in claim 15, further comprising:
determining an average value of a current through the inductive element during a switching period, and
setting the first and second time durations depending on said average value.

17. The method as claimed in claim 15, further comprising:
determining a difference between a first voltage across the first storage cell and a second voltage across the second storage cell.

18. The method as claimed in claim 17, wherein the first and second time durations are set depending on said difference.

19. A circuit arrangement comprising:
a first capacitive storage cell and a second capacitive storage cell,
an inductive charge storage element,
a switch arrangement that couples the inductive storage element during temporally successive switching periods, in parallel with the first storage cell for a first time duration and in parallel with the second storage cell for a second time duration.
